(19) United States
(12) Patent Application Publication
(10) Pub. No.: US 2024/0406175 A1
(43) Pub. Date: Dec. 5, 2024

(54) Method of controlling an access to an application service implemented in a telecommunications network, method of processing a control message for an access to said application service, corresponding devices, control equipment, client equipment, system and computer programs

(71) Applicant: ORANGE, ISSY LES MOULINEAUX (FR)

(72) Inventors: Mohamed Boucadair, CHÂTILLON CEDEX (FR); Christian Jacquenet, CHÂTILLON CEDEX (FR)

(21) Appl. No.: 18/695,571

(22) PCT Filed: Sep. 26, 2022
(86) PCT No.: PCT/FR2022/051802

§ 371 Date: Mar. 26, 2024

(30) Foreign Application Priority Data
Sep. 27, 2021 (FR) FR2110174

(51) Int. Cl. H04L 9/40; H04L 41/16; H04L 41/5009

(52) U.S. Cl. CPC H04L 63/10; H04L 41/16; H04L 41/5009

(57) ABSTRACT

A method of controlling an access by at least one item of client equipment to an application service in a telecommunications network. The at least one item of client equipment is configured to access the application service. The method includes: obtaining event information relating to the processing, by at least one item of service equipment involved in implementing the application service, of messages exchanged during at least one access to the application service; detecting, from the information obtained, a processing anomaly by at least one the item of service equipment in relation to at least one given service execution criterion; and transmitting at least one control message containing at least one control action of a processing of at least one access request to the service by the item of client equipment.

### 1. FIELD OF THE INVENTION

The invention lies in the field of telecommunications, and notably in the field of IP telephony. In particular, the invention relates to the control of the access by client equipment to an application service implemented in a telecommunications network. It applies notably, but not exclusively, to a voice over IP service.

### 2. PRIOR ART AND ITS DISADVANTAGES

Telephony over IP, often referred to by the acronym VoIP (for “Voice over IP”), has become so popular in recent years that all service providers are now offering such services to their clients. These services are based on the Internet Protocol (IP) and therefore on the switching of data packets. They therefore differ in design from traditional telephony services, which are based on the principle of circuit switching.

Nevertheless, IP Telephony must meet clients' needs, particularly in terms of service quality and availability, which must be at least equivalent to those provided by traditional telephony offerings based on the PSTN (Public Switched Telephone Network). In particular, quality of service, robustness, high availability and resistance to breakdowns are determining factors for users of telephone services, which are by nature real-time flow exchange services. Telecommunications operators, also known as service providers, have a particular responsibility to avoid overloading the elements that make up the service and to anticipate anomalies that could disrupt the service as perceived by clients.

Overload refers here to the inability of the service, or certain elements of the service, to handle a request to establish an application session, for example an audio, video or IM (Instant Messaging) call, often due to insufficient resources to handle said request.

Managing overloads is all the more tricky because the phenomenon tends to be self-sustaining. In fact, the nature of the overload problem is gradually to affect the elements of the service involved in the call establishment procedure, which are still trying to handle the traffic: these elements are therefore in turn affected by a traffic overload.

When a service element is in a state of overload, some of its resources are used to send error messages, alerts, etc., which has the effect of further reducing the resources available to resolve the overload problem. In the case of an IP Telephony service, an additional degrading factor is the retransmission of requests, which is often used to compensate for any IP transport errors. For example, RFC 3261, which defines the SIP (Session Initiation Protocol) signalling protocol used in the call establishment procedure, describes a retransmission procedure for INVITE and non-INVITE messages. For example, for INVITE messages, a retransmission timer T1 is defined. The procedure is repeated for each interval corresponding to a duplicate of T1. After 7 attempts, the item of SIP client equipment stops executing the retransmission procedure.

Engineering rules enable telecoms operators to avoid this type of crisis situation under normal operating conditions, by adequately dimensioning their service or, for example, by implementing load balancing mechanisms between the service elements that make up the service. However, most of the time these mechanisms are insufficient to handle the large number of sessions (for example, calls) linked to exceptional events (such as, for example, the exchange of SMS greetings for the New Year, a natural disaster, a TV programme based on viewer voting, a power cut, a terrorist attack, etc.) or following a breakdown (affecting client equipment or the elements that make up the service platform). Current conversational services are particularly weak when it comes to managing bursts. Typically, conversational services over IP experience serious failures, which are amplified by the overload generated when the service is restored, thereby delaying the restoration of the service. Such circumstances often make the resumption of service unmanageable, sometimes to the point of causing crisis situations not controlled by the telecoms operator. In this respect, the occurrence of such a crisis may not be taken into account when designing the service and the underlying network.

One of the most difficult overload phenomena to understand is the phenomenon of flash crowds. In particular, it occurs when too many users try to make a call or connect to a website at the same time, and the service elements have not been designed to absorb the burst of traffic. For example, the sizing of telephone networks is based on the statistical distribution of calls, governed by Erlang's laws in particular. However, this type of sizing does not allow the deployment of a service that can cope with occasional traffic surges. In the case of a Flash Crowd phenomenon, the origin of a bottleneck in a service platform can be linked to at least two specific situations:
(1) a large influx of sessions to a particular destination (e.g. a particular number such as an emergency number or a particular geographical area) or
(2) a large influx from a particular region (in terms of connection to the service) or a combination of both situations, in the context of natural disasters, for example.

This type of situation can generate a large number of sessions to the number in question over a relatively short period of time, causing congestion that degrades the quality of the service provided as perceived by users.

Another well-known example is the almost systematic saturation of telephone networks during the festive season, particularly on New Year's Eve. Here again, the operator's service is often designed to be able to handle a large number of client calls under nominal operating conditions, i.e. as provided for in a specification or in a contract specifying the general conditions of use (GCU) of the service, drawn up with the clients. On the other hand, when peak loads occur, the system that implements the service is generally unable to cope with the overload of calls, which can lead to a significant degradation in the service, or even its unavailability. Such an influx of call establishment requests is also likely to delay the return to a normal situation because of the persistence of this influx of traffic over time.

The various failures that have affected IP Telephony services in recent years have shown that the system that implements the service often has great difficulty in absorbing an exceptional overload.

IP telephony service engineering is essentially based on adequate sizing (including over-sizing) to meet the service access requests of clients who have subscribed to the service. They also rely on load sharing mechanisms to limit the risk of overload. However, experience has shown that these engineering choices, while suitable for nominal operational use, are much less so for responding to sudden overloads caused by exceptional events or unforeseen behaviour of a service element (for example, partial software failure leading to a random loss of session).

In relation to FIG. 1, a simple practice implemented today consists of informing clients of the presence of an overload situation in the process of being resolved. This can be done, for example, by sending an error code when trying to set up a call using the SIP protocol, or by WebRTC (Web Real Time Communication). This error code specifies the problem encountered. In an SIP environment, for example, document RFC 3261 defines the response code “503” which must be transmitted by a service element in an overload situation to any item of client equipment or User Agent (UA) that has requested this element. Sending an SIP error message with this code means that the requested service element is unable to process the request due to a temporary overload or maintenance operation. The service element in question can indicate a time limit after which the client can make a new attempt (using the “Retry-After” header). A UA client receiving such a response code is expected to request another service element to satisfy its request, at least until the “Retry-After” time limit (if specified) has expired and if the possibility of contacting another service element is offered. In this respect, it should be noted that a procedure for determining such a time limit is difficult to establish. The implementation of such a procedure by the congested service element may even aggravate the situation and keep it in a state of permanent overload. The example in FIG. 1 shows an exchange of messages between an agent UA1 of the user and a service element PS, of the proxy server type. UA1 sends an INVITE request to establish a call to PS. As the service is unavailable, it generates a response of type “503 Service Unavailable” to notify the client that it is impossible to access the service. This assumes that the SIP procedure can generate such a message and that the operator has the capacity to carry out the associated processing in the event of an overload.

Another well-known practice is to send congestion or overload notifications in SIP messages of the OPTIONS or NOTIFY type.

A common feature of these practices is the involvement of the congested service element in the resolution, notification and management of the overload situation. However, they both have a number of limitations.

An alternative is for the service elements to add an information field dedicated to dealing with congestion/overload phenomena. The aim of this alternative is to provide a better qualification of the state of congestion and to minimise the approximations of the mechanisms described above. It is based on a dedicated SIP header, called “CONGESTION”, which can be inserted in any SIP response. In particular, it is used to characterise the degree of congestion observed (value ranging from 0 to 4), the type of congestion (e.g. CPU, network), the service element concerned and a time limit after which a new attempt can be made. However, this alternative has the same disadvantages as using the “Retry-After” field, because the service element has to generate a message and execute a procedure to determine (or even predict, given current and future demands) when it will return to normal (i.e. nominal operation), which is not easily achievable during exceptional overload phenomena (e.g. crises or major events).

Document RFC7339 defines various methods of control and associated algorithms. In particular, it describes how an overloaded service element can tell other service elements soliciting it to reduce the number of messages they send it, so that they can regulate incoming solicitation in the event of overload. To achieve this, SIP parameters dedicated to load management and called “oc” (for “overload control”), “oc-algo”, “oc-validity”, and “oc-seq” have been defined to include various information to characterise the rate and conditions of overload. One advantage of the methods described in document RFC7339 is that they enable better management of overload situations than the method described in document RFC3261, but they do not guarantee rapid eradication of the overload phenomenon or enable it to be predicted. On the contrary, when faced with a “Flash Crowds” type of overload problem, the service element suffering the traffic peak must trigger all the processes described in document RFC7339, which increases the number of operations it has to perform, and therefore contributes to worsening its overload state. As a result, the time needed to absorb the influx of traffic is increased.

The international patent application published under number WO2009/122071 describes a method for preventively managing an overload situation, the aim of which is to prevent a burst from impacting the service platform so that the service becomes unavailable, for example a burst caused by a “Flash Crowd” type phenomenon. This process consists of filtering service access requests at the border equipment level. This filtering is controlled by the prior definition and measurement of relevant thresholds to characterise the onset of an overload phenomenon. These thresholds are defined by the service operator. They take into account a maximum limit supported by the service element and a ratio in relation to this limit which represents the limit value accepted in an operational situation. Clipping the flow of requests to be processed in this way protects the service platform and ensures that it is always able to absorb the traffic it receives. Unlike the other practices mentioned above, this filtering operation makes it possible to regulate traffic peaks before they affect the operation of the service platform.

However, it is possible that elements other than the service platform involved in the implementation of the service may experience failures or anomalies. Such elements are, for example, border elements which relay application session establishment messages between user terminals and the service platform. These sessions are supported by service access networks through which user agents transmit service access requests, or interconnection elements to other networks (e.g. PSTN or PLMN (Public Land Mobile Network) interconnection).

The invention provides a mechanism for managing such a situation.

### 3. DISCLOSURE OF THE INVENTION

The invention responds to this need by proposing a method of controlling access by at least one item of client equipment to an application service in a telecommunications network, said at least one item of client equipment being configured to access said application service, said method comprising:
obtaining event information relating to the processing, by at least one item of service equipment involved in implementing the application service, of messages exchanged during at least one access to said application service;
detecting, from the information obtained, a processing anomaly by at least one said item of service equipment in relation to at least one given service execution criterion; and
transmitting to said item of client equipment at least one control message comprising at least one control action of a processing of at least one access request to said service to be executed by said item of client equipment.

The invention proposes a completely new and inventive approach to managing an overload or failure situation experienced by a system implementing an application service in a telecommunications network. It consists of observing the operation of the service equipment of this system by collecting information relating to processing events of messages exchanged during access to this service at the level of this equipment, and, in the event of an anomaly being detected in relation to one or more given service execution criteria, deciding on one or more actions to control the processing of at least one access request to the service by said item of client equipment. Advantageously, the control action has the effect of modifying an initial network configuration made when the item of client equipment was started up. To this end, it includes, for example, one or more control parameters for the processing of an access request to the service by the item of client equipment. The invention applies to an item of client equipment that is already configured to access the service and already has access to it. The control mechanism for processing an access request to the application service by the item of client equipment according to the invention therefore differs from a procedure for the initial configuration of an item of client equipment intended to enable it to access the service.

In this way, any processing anomalies that could lead to a crisis/overload situation and impact the correct execution of the service as defined by said criteria are managed in advance, at the source of the service access requests and outside the system, without impacting the core service equipment (or service platform).

In contrast to the prior art, the aim is no longer only to detect and avoid a state of overload of an item of service equipment, but above all to detect or even anticipate an anomaly or failure in the implementation of the service by one or more items of service equipment, before it creates a situation of overload and above all before it is detrimental to the correct execution of the relevant service.

According to the invention, execution criteria generic to the various services and/or specific to the service in question are defined and taken into account, and used to detect processing anomalies such as deviations from nominal operating conditions, which makes it possible to decide in a relevant manner on the most appropriate control action(s).

According to the invention, these control actions are intended for the client equipment itself so as to act as close as possible to the source of the service access requests while minimising the impact on the operation of the core system. This makes it possible to modify the way in which they process an access request to the service or a message for the establishment of an application session and offers far more possibilities for adjustments than a simple random filtering of traffic at the entrance to the service platform, as proposed in the prior art.

While such filtering protects the service platform from overload, it does not take into account the type of service or any criteria for assessing whether the filtering measures implemented at the border equipment enable the application service to be rendered under acceptable operating conditions that are satisfactory to the user.

Thus, by taking into account execution criteria specific to the relevant application service, the invention can adapt the control carried out on the client equipment.

Advantageously, the control action comprises a configuration parameter for the item of client equipment so that the latter modifies its initial configuration.

The invention is based on known signalling mechanisms already used to provide the service, without requiring any particular extension. For example, a management protocol of the configuration of the network equipment such as NETCONF or RESTCONF can be used. Such a protocol uses the XML language to encode configuration data as well as the messages of the protocol. For the format and structure of processing event notifications, a data modelling language such as YANG can be used, by defining a dedicated YANG module.

The invention applies to any type of application service, but is particularly interesting in the case of an IP telephony service, notably when faced with a “Flash Crowd” type situation.

According to at least one aspect of the invention, said method comprises the prior learning of a classification model of an automatic detection system of a said processing anomaly from a learning set comprising processing event information previously labelled using at least two classes comprising an anomaly presence class and an anomaly absence class and said detection of an anomaly is performed by said system from processing event information obtained for one or more items of service equipment involved in the implementation of the relevant service, said system producing at the output one of the at least two classes.

For example, such a system uses a classification model determined using artificial intelligence techniques such as machine learning to collect and classify the observed data, and an algorithm (such as reinforcement learning) to assist decision-making on how to deal with the crisis situation. One advantage is to determine an optimum operating situation for an item of service equipment or a set of items of service equipment to provide the service in question.

According to another aspect of the invention, said control action belongs to a group comprising at least:
a control action of a temporal spread of transmissions of requests for establishing application sessions by said item of client equipment;
a control action of a number of attempts by said item of client equipment to establish an application session at said service;
a checking action on a replacement number for the telephone number associated with the service requested by said item of client equipment;
a control action of a priority of the service, comprising the configuration of priority levels assigned to the requested services and to the other services to which said item of client equipment can access;
a control action of an automatic programming of an announcement server of a replacement number for a telephone number associated with the service requested by said item of client equipment.

One advantage is that the adjustment of the configuration of the service equipment and/or client equipment proposed by the invention makes it possible to regulate, redirect or even prioritise traffic according to the service requested.

According to yet another aspect of the invention, when said application service comprises the establishment of a telephone call, said control action comprises configuring at least one telephone number, known as an alias number, to replace a telephone number associated with the service.

Advantageously, such an alias number can be used to access the switchboard via another network route. For an emergency service, for example, the aim is for the service to be provided for all access requests received by the system. One advantage of the invention is that it allows the configuration of another telephone number via which the emergency centre, although saturated on its main telephone number, can still be reached. This configuration is transparent to the user, who can continue to dial the usual telephone number and is not even aware that their request has been redirected.

The invention thus offers a reliable solution for managing a peak overload in an application service, in particular a Public Safety Answering Point, without requiring a user in a state of extreme stress to consult a social network to find out about an alternative telephone number set up by the service operator, for example.

Alternatively, when said application service comprises establishing a telephone call, said control action comprises automatically programming a server to announce a replacement telephone number for a destination telephone number.

Alternatively, when a user attempts to establish a telephone call with a destination telephone number (e.g. associated with the switchboard, an emergency centre, an international call) and a replacement number has been set up because it is temporarily unreachable, the programming server announces the replacement number to be dialled to the user.

According to another aspect of the invention, said at least one service execution criterion comprises a telephone call establishment failure rate equal to zero and a telephone call establishment delay below a predetermined threshold.

For an emergency service, communication with the emergency centre must be established successfully in 100% of cases and within a reasonably short time.

The invention also relates to a control device of an access by at least one item of client equipment to an application service in a telecommunications network, said at least one item of client equipment being configured to access said application service, said device being configured to implement:
obtaining event information relating to the processing, by at least one item of service equipment involved in implementing the application service, of messages exchanged during at least one access to said application service;
detecting, from the information obtained, a processing anomaly by at least one said item of service equipment in relation to at least one given service execution criterion; and
transmitting to said item of client equipment at least one control message comprising at least one control action of a processing of at least one access request to said service to be executed by said item of client equipment.

Advantageously, said device configured to implement the steps of the method for controlling an access as described above.

Advantageously, said device is integrated into an item of control equipment of at least one item of service equipment involved in the implementation of an application service in a telecommunications network.

Advantageously, said item of control equipment is included in a system for implementing an application service in a telecommunications network, said system comprising a plurality of items of service equipment involved in implementing said service.

The system, the item of control equipment and the control device have at least the same advantages as those conferred by the above-mentioned method of control.

Correlatively, the invention also relates to a method for processing a control message of an access to an application service involving at least one item of service equipment in a telecommunications network, said method being executed by an item of client equipment configured to access said application service, said method comprising:
receiving the control message from an item of control equipment of said telecommunications network, said control message comprising at least one control action of a processing of at least one access request to said service by said of client equipment, and
executing the control action when processing said request.

With the invention, the item of control equipment acts on the item of client equipment so as to adjust the way in which it processes access requests to the application service. In this way, it intervenes at the source so as to correct without delay the operating anomaly or anomalies observed in one or more items of service equipment constituting the system for implementing the application service.

According to one aspect of the invention, when the requested service comprises establishing a telephone call with a destination and the control action comprises configuring at least one alias telephone number of a telephone number associated with the requested service, performing the action comprises:
modifying a header of the message requesting access to said service, comprising the replacement of the telephone number associated with the requested service by said alias telephone number.

For example, the item of client equipment performs this replacement in the “Request URI” field of the “To” header of the service access request.

One advantage of making this modification at the level of the item of client equipment is that the headers are not yet encrypted. It is indeed common for service equipment to use encryption protocols for certain message headers or certain information fields contained in these headers.

The invention also relates to a device for processing a control message of an access to an application service involving at least one item of service equipment in a telecommunications network, said device being intended to be executed by an item of client equipment configured to access said application service, said device being configured to implement:
receiving a control message from an item of control equipment of said telecommunications network, said control message comprising at least one control action of a processing of at least one access request to said service by said item of client equipment, and
executing the control action when processing said request.

Advantageously, said device is configured to implement the steps of the method for processing a message for controlling an access as described above.

Advantageously, said device is integrated into an item of client equipment of a client domain configured to access an application service, said service being implemented by at least one item of service equipment of a telecommunications network. It can also be integrated into the system that implements an aforementioned application service.

The system, the item of client equipment and the processing device have at least the same advantages as those conferred by the above-mentioned method of control.

The invention also relates to computer program products comprising program code instructions for implementing the methods as described previously, when they are executed by a processor.

A program can use any programming language, and can be in the form of source code, object code, or intermediate code between source code and object code, such as in a partially compiled form, or in any other desirable form.

The invention also relates to a computer-readable storage medium on which is saved a computer program comprising program code instructions for implementing the steps of the methods according to the invention as described above.

Such a storage medium can be any entity or device able to store the program. For example, the medium can comprise a storage means, such as a ROM, for example a CD-ROM or a microelectronic circuit ROM, or a magnetic recording means, for example a mobile medium (memory card) or a hard disk or SSD.

On the other hand, such a storage medium can be a transmissible medium such as an electrical or optical signal, that can be carried via an electrical or optical cable, by radio or by other means, so that the computer program contained therein can be executed remotely. The program according to the invention can be downloaded in particular on a network, for example the Internet network. Alternatively, the storage medium can be an integrated circuit in which the programs are embedded, the circuit being adapted to execute or to be used in the execution of the above-mentioned methods.

According to an embodiment, the present technique is implemented using software and/or hardware components. In this context, the term “module” may be used in this document to refer to a software component, a hardware component or a combination of hardware and software components.

A software component is one or more computer programs, one or more subroutines of a program, or more generally any element of a program or software capable of implementing a function or set of functions, as described below for the module concerned. Such a software component is executed by a data processor of a physical entity (terminal, server, gateway, set-top-box, router, etc.) and is able to access the hardware resources of this physical entity (memories, recording media, communication buses, electronic input/output cards, user interfaces, etc.). Hereafter, resources are understood to be any set of hardware and/or software elements that support a function or service, whether individually or in combination.

In the same way, a hardware component is any element of a hardware assembly capable of implementing a function or set of functions, as described below for the module concerned. It may be a programmable hardware component or a component with an embedded processor for executing software, for example, an integrated circuit, a smart card, a memory card, an electronic card for executing firmware, etc.

Each component of the system described above naturally implements its own software modules.

The various embodiments mentioned above can be combined with each other for the implementation of the present technique.

### 4. BRIEF DESCRIPTION OF THE FIGURES

Other purposes, features and advantages of the invention will become more apparent upon reading the following description, hereby given to serve as an illustrative and non-restrictive example, in relation to the figures, among which:

FIG. 1 (already described) diagrammatically illustrates an example of notification of a state of overload by an item of service equipment involved in the implementation of an application service to an item of client equipment wishing to access the service, according to the prior art;

FIG. 2 diagrammatically illustrates an example of the architecture of a system for implementing an application service in a telecommunications network to which an item of client equipment accesses according to an embodiment of the invention;

FIG. 3 details an example of the structure of an item of control equipment of such a system and an item of client equipment according to an embodiment of the invention.

FIG. 4 diagrammatically illustrates an example of the architecture of a system for implementing an application service according to another embodiment of the invention;

FIG. 5 describes in the form of a flowchart the steps of a method for controlling access to an application service implemented in a telecommunications network, according to an embodiment of the invention;

FIG. 6 describes in the form of a flowchart the steps of a method for processing a control message of an access to an application service implemented in a telecommunications network, according to an embodiment of the invention;

FIG. 7 diagrammatically illustrates an example of nominal operation of the application service;

FIG. 8 diagrammatically illustrates an example of a service operation anomaly;

FIG. 9 diagrammatically illustrates an example of control carried out on an item of client equipment, according to an embodiment of the invention;

FIG. 10 describes an example of a hardware structure of a control device of an access to an application service according to the invention; and

FIG. 11 describes an example of the hardware structure of a device for processing a control message according to the invention.

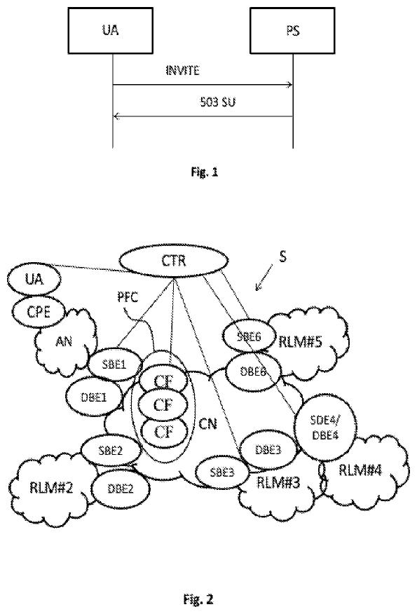

### 5. DETAILED DESCRIPTION OF THE INVENTION

The general principle of the invention is based on the control of an access by at least one item of client equipment to an application service implemented by a system comprising a plurality of items of service equipment in a telecommunications network. This control is based on obtaining event information relating to the processing, by at least one of the system's items of service equipment, of messages exchanged within the framework of the implementation of said application service, detecting, from the information obtained, a processing anomaly by said item of service equipment in relation to at least one given execution criterion of the service, and transmitting at least one control message comprising at least one control action of the processing of said at least one access request to said service by said item of client equipment.

The invention applies to any type of application service whose access is provided by establishing an application session between a requesting client device and such a system, for example an audio, video or IM instant messaging call.

It applies to all types of telecommunications network. In the remainder of the description, however, a more detailed description will be undertaken of the case of an IP telecommunications network (RT) and a telephony over IP service. Given current deployments of telephony over IP, the following examples will be based on the SIP protocol.

Naturally, the embodiments, particularly the protocols envisaged in these embodiments, are cited by way of example only.

In the following, the term item of service equipment or element will be used interchangeably to refer to any element solicited to provide a service (and in particular to establish an application session).

Such an item of equipment or element may be involved in the exchange of control messages (using the SIP protocol, for example), the exchange of useful data (using the RTP protocol, for example), or both.

The implementation of a service may involve one or more service elements.

The order in which service elements are invoked can be static and specific to a service (e.g. conforming to the IMS architecture) or can be established on demand (e.g. using a service chaining technique).

A service element can be implemented in software and/or hardware. One or more service elements can be embedded in the same piece of physical equipment.

FIG. 2 diagrammatically illustrates an example of the architecture of a system S for implementing an IP telephony service deployed by a service provider in a telecommunications network RT, according to one embodiment of the invention. In FIG. 2, an item of client equipment or UA (User Agent) configured to access the service is also shown. This user agent can also be embedded in a CPE (client Premises Equipment) user terminal. Typically, this is any equipment installed at or used by the user to create, route or terminate a communication between the user and the operator's or service provider's system, such as a residential or professional gateway or smartphone. Alternatively, the UA can be integrated into an item of dedicated equipment. Where a CPE is present, it usually carries a proxy server, which is not shown.

In this example, the item of client equipment UA, CPE accesses the network RT via an access network AN, for example of the cellular radio, fibre or ADSL type.

The system S of FIG. 2 comprises the following elements:
Border service elements or equipment, referred to here as SBE (Session Border Element) and DBE (Data Border Element). The SBE element is responsible for processing signalling messages, while a DBE element is responsible for processing media streams. These two elements can be embedded in the same item of equipment or in separate items of equipment. An example of an implementation of the SBE element is the P-CSCF function (or “proxy-call/session control function”, while the BGF function (Border Gateway Function) is an example of an implementation of the SBE element. The SBC (Session Border Controller) function is another example of an implementation that supports both the SBE and DBE elements.

Note that:

When these SBE/DBE elements are directly connected to the UAs, they are the contact points for the system implementing the service. In this configuration, UAs have no visibility of the internal structure of a core PFC platform for implementing the service.

These elements can also be used for interconnection with other domains (identified by “RLM #r” in FIG. 2, with r an integer between 2 and 5). These domains can be other IP telephony domains, another telecommunication network such as the PSTN network or a mobile network, etc.
The PFC core platform, made up of elements called CF (Core Functions) located in the core network CN, not shown. In fact, the invention can be used generally regardless of the underlying service architecture, which is for example an IMS (or “IP Multimedia Subsystem”) architecture or any other future architecture. No assumptions are made as to the nature of the CFs, their number, or the sequence in which they are invoked to establish an application session.

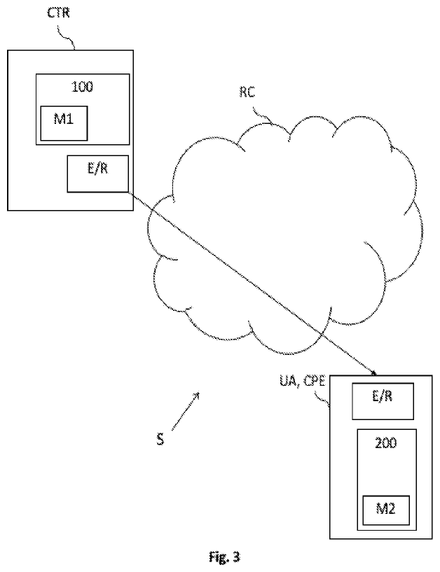

According to this embodiment of the invention, the system S also comprises an item of control equipment, or controller CTR, configured to control the service equipment and the UA, CPE client equipment. One example is an SDN (Software-Defined Networking) controller, as shown in FIG. 3. It is responsible for managing and configuring service elements. The NETCONF or RESTCONF protocols are used as examples to manage and configure these elements, but other protocols may be used.

In this example of an embodiment of the invention, the item of control equipment CTR comprises a control device 100 of an access by at least one item of client equipment to an application service in a telecommunications network, said at least one item of client equipment being configured to access said application service. It is configured to obtain event information relating to the processing, by at least one item of service equipment involved in implementing the application service, of messages exchanged during at least one access to said application service, detecting, from the information obtained, a processing anomaly by at least one said item of service equipment with respect to at least one given execution criterion of the service; and transmitting at least one control message comprising at least one control action of a processing of at least one access request to said service by said item of client equipment.

The device 100 thus implements the method for controlling an access to the service according to the invention that will be detailed hereafter in relation to FIG. 5.

Alternatively, the device 100 may be independent of the item of control equipment, but connected to it by any link whatsoever, wired or not. For example, it can be integrated with another item of equipment of the telecommunications network, for example an item of service equipment.

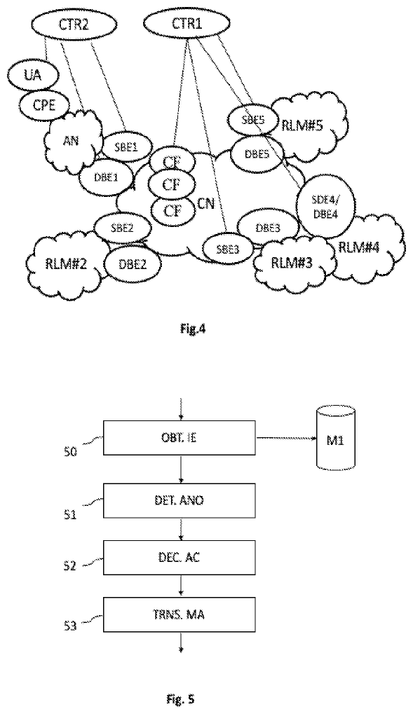

Several controllers can be deployed, as illustrated in FIG. 4. In this second example, a first controller is responsible for the service elements of the service provider, while a second controller is used for managing the client equipment (UA, CPE).

If several controllers are present, it is assumed that they interface for the needs of coordination and status synchronisation, if necessary, in a way that is known per se.

According to this embodiment of the invention, the client equipment UA, CPE comprises a processing device 200 of a control message of an access to the application service involving at least one item of service equipment in the telecommunications network RT This device 200 is configured to receive a control message from an item of control equipment of said telecommunications network, said control message comprising at least one control action of a processing of at least one access request to said service by said item of client equipment, and executing the control action when processing said request.

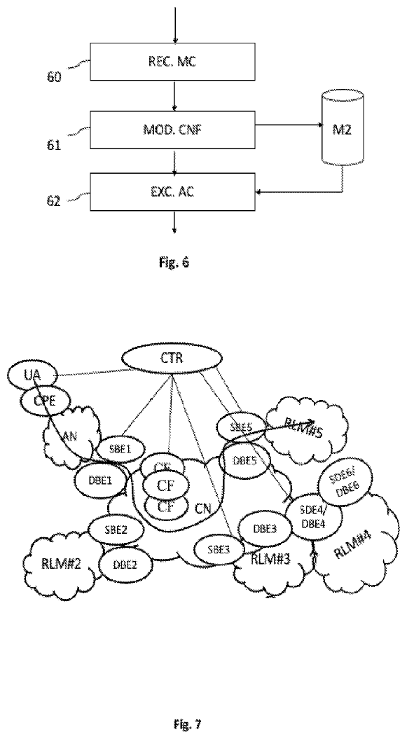

The device 200 thus implements the method for processing a control message of an access to the application service according to the invention that will be detailed hereafter in relation to FIG. 6.

In relation to FIG. 5, an embodiment of a method for controlling an access to an application service by at least one item of client equipment, according to one embodiment of the invention is now presented in the form of a flowchart. In the following, this method is implemented by the above-mentioned device 100.

In 50, information of events relating to the processing by at least one item of service equipment involved in an implementation of the application service, of messages exchanged during at least one access to said application service, is obtained.

For example, the control device 100 receives this information (directly or indirectly) from the service equipment it controls. It reflects the status of such an item of service equipment. Advantageously, it stores them in a memory M1, structured or not. For example, such a memory is organised in the form of a database and indexed by an identifier of the item of service equipment concerned by the item or items of information received.

For example, the format of the notifications containing this information is defined using a data modelling language. For example, this is the YANG language for modelling data that can be conveyed, for example, in NETCONF or RESTCONF protocol messages. This is a modular language representing data structures in an XML tree format. The data modelling language comes with a number of integrated data types. Other application-specific data types can be derived from the integrated data types. In particular, according to the invention, the data types of the information received from the service equipment by the item of control equipment can be specified in a dedicated Yang module. This processing event information may or may not be solicited. Solicited responses are responses to explicit requests such as GET requests sent by the control device 100, while unsolicited responses are typically notifications sent by an item of service equipment without a specific request having been sent. NETCONF/RESTCONF notifications are examples of unsolicited responses. For example, notifications can be generated based on filters maintained locally by this item of service equipment. These notifications may consist of informing the controller of:
an observed failure rate on a given interface of the item of service equipment
a failure rate to establish all sessions handled by the item of service equipment,
a failure rate to establish the moving average of sessions handled by a service element,
a failure rate to establish application sessions to a specific destination or service (for example, a server identified by an IP address, a website, an E.164 number, or an SIP alias),
a response time (i.e. the time between sending a request and receiving a corresponding response),
a failure rate to establish sessions to one of the destinations (e.g. E.164 numbers or SIP aliases) served by the item of service equipment,
a level of CPU load on the item of service equipment,
a session log for the item of service equipment,
etc.

In 51, a processing anomaly by at least one said item of service equipment is detected from the information obtained and in relation to at least one given execution criterion of the service. In other words, anomalies at the service level can also be detected in addition to anomalies at the level of an item of service equipment.

These execution criteria of the service can be generic to any type of service and/or specific to the relevant application service. For example, for an emergency service such as 15, a first criterion may be a failure rate to establish call session equal to zero and a call session establishment time of less than one minute, for example.

This or these given execution criteria help to define nominal operation of the service and also of the service equipment involved, and the detection of an anomaly according to the invention comprises detecting at least one deviation in operation of said at least one item of service equipment from nominal operation.

Advantageously, the method comprises the learning of a classification model of a system of automatic decision-making from a learning set comprising processing event information previously labelled using at least two classes comprising an anomaly presence class and an anomaly absence class and the detection is performed by the decision-making system that takes as input the processing event information obtained for one or more items of service equipment involved in the implementation of the relevant service, and provides at the output a detected anomaly presence or detected anomaly absence decision. For example, such learning uses machine learning ML techniques to feed the computation logic of the device 100 and determines the classification model. It should be noted that anomaly detection can be performed per item of service equipment, for a plurality of items of service equipment involved in implementing the relevant service, for the items of service equipment associated with the same global PFC core platform for several services, etc.

It should also be noted that an anomaly decision can be taken on the basis of an accumulation of processing anomalies detected at the level of different service equipment.

In 52, when a processing anomaly has been detected in one or more items of service equipment, a decision is taken to order the execution of at least one control action of a processing of at least one access request to said service by at least one item of client equipment UA, CPE.

Depending on the given execution criterion or criteria used to detect an anomaly or failure, the anomaly detected and other information relating to the architecture or the operation of the system, such as scheduled maintenance work, for example, the control device 100 decides to proceed to:
control of the load at the level of one or more items of client equipment, with a certain level of granularity (for example, by telephone number or range of telephone numbers of the items of client equipment);
control of the temporal spread of the creation of new application sessions at the level of items of client equipment UA, CPE;
control of the number of attempts taken into account to establish an application session requested by the item of client equipment. This number can be defined per range of telephone numbers, typically a larger number can be defined for emergency calls than for other application services;
supply of a list of replacement or alias telephone numbers directly to the item of client equipment.

For example, if a route is unavailable to reach an abbreviated number (for the fire brigade emergency service 18, for example), client equipment can be dynamically configured with a list of aliases to be used instead of the telephone number associated with the service requested. According to a variant implementation, it is also possible to configure bypass numbers to react to the unavailability of interconnection equipment (e.g. equipment enabling an operator to connect to another operator's network). The item of client equipment UA, CPE will automatically replace the unavailable number with a bypass number. Calls will therefore be intercepted by an associated item of bypass equipment, which will then replace the bypass number with the original number before transmission;
prioritisation of certain numbers, such as emergency numbers, using dedicated filters communicated to the UA, CPE (or even SBE);
automatic programming of an Announcement Server to announce replacement numbers when the UA calls the abbreviated code of the service;
etc.

It should be noted that these control actions are intended for client equipment requesting access to the application service, but that they can also be controlled by service equipment, in particular border equipment (SBE). This is particularly the case for the prioritisation of certain telephone numbers through the implementation of dedicated filters.

Of course, these actions can be combined. For example, the control device 100 may decide, in order to enable an application service to be restarted without it being collapsed by traffic peaks immediately after the service has been restored, to act on the spread of the processing of requests to establish application sessions sent by a UA and/or on the establishment of relaying by an item of border equipment to an SBE/DBE and/or on the redirection of requests to an announcement server, and so on.

In 53, at least one control message comprising at least one control action is transmitted to one or more items of client equipment UA, CPE.

In relation to FIG. 6, an embodiment of a method for processing a control message of an access to an application service involving at least one item of service equipment in a telecommunications network, is now presented in the form of a flowchart.

In the following, this method is implemented by the aforementioned device 200, integrated into an item of client equipment UA, CPE configured to access said application service.

In 60, a control message MC is received from an item of control equipment CTR of said telecommunications network, said control message comprising at least one control action AC of a processing of at least one access request to said service by said item of client equipment. For example, it records the control action received in an M2 memory.

In 61, the device 200 modifies its initial configuration to take account of the control action received. For example, when the control action includes an alias number to be used to replace the telephone number associated with the relevant application service, the device 200 stores this alias number in a memory and modifies its procedure so as systematically to replace the telephone number associated with the service by this alias. The actions, for example, are defined using regular expressions (“regexp”).

In 62, it performs the control action when processing said service access request.

For example, when it receives a request to access the service, it first looks in memory to see if an alias number exists for this request. If so, it automatically replaces the telephone number associated with the requested service in the “Request URI” field and the “To” header of the application session establishment request. Unlike the state of the art, this UA action is transparent to the user and it is executed immediately. Having the UA execute this action is particularly advantageous when encryption protocols (and the “sips” URI) are used by service equipment, as it is performed at the source, i.e. before encryption is carried out.)
An example of a nominal configuration for a given destination, for example an emergency call centre located in a destination domain, for example the IP domain RLM #5 and associated with a telephone number, for example abbreviated code 18, is now shown in relation to FIG. 7. For the purposes of this example, it is assumed that the destination domain RLM #5 can also be reached using another telephone number, known as an alias. In this example, a call from the item of client equipment UA, CPE is routed to the call centre under nominal operating conditions. In other words, the application session is successfully established in less than the maximum authorised time.

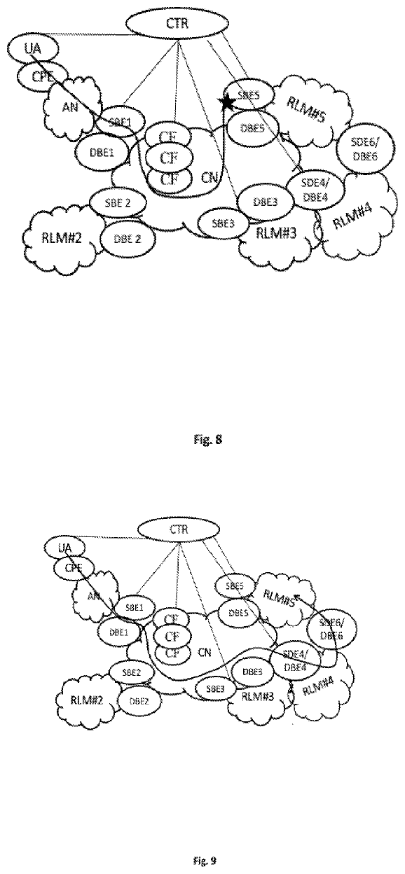

FIG. 8 shows an example of the failure to establish an application session requested by the item of client equipment UA, CPE. It is assumed that the access control process according to the invention implemented by the item of control equipment CTR has detected a malfunction of an item of border equipment SDE5/DBE5, more specifically the interconnection between the core network CN and the IP domain RLM #5. This failure affects the implementation of one or more application services, whose call management centre is located in this IP domain.

According to the invention, the control equipment transmits a control message to the item of client equipment UA, CPE.

This message includes a control action which consists of configuring an alias list associating an alias number with the telephone number of each of the services concerned. On receiving the list of aliases, the item of client equipment UA, CPE modifies its initial configuration so as to use this list to rewrite automatically the “Request URI” (and “To”) field of any request to establish an application session to access one of these services, replacing the telephone number associated with the requested service by its alias. In this way, and as illustrated in FIG. 9, the call can be successfully routed via the neighbouring IP domain RLM #4. Said list of aliases can also be associated with a validity date beyond which it is automatically deleted from the memory of the UA, CPE unless a control action is received with a request to update the validity date to another date, later or earlier depending on how quickly the operation failure is corrected.

Alternatively, the processing control of a service access can also be carried out by the item of control equipment CTR at the CPE of the user or the item of border equipment SBE1 located in the access network AN. The controller configures the CPE or SBE1 with a list of aliases. This list is used by the border device SBE1 to rewrite the “Request URI” (and “To”) field of the request to set up an application session. The emergency call can be successfully routed via the neighbouring IP domain RLM #4.
The redirection of all or part of the traffic to the requested destination as implemented according to the invention also makes it possible to reduce the processing load on the faulty service equipment and makes it easier to carry out maintenance operations such as a restart, for example. A second example of the application of the invention involves an electronic voting service. Each voter is invited to submit their vote (on the occasion of a television programme or an election, for example) by accessing a website. The vote validation procedure is based on an acknowledgement mechanism which consists of sending the voter a message confirming that the vote has been taken into account (and that it complies with the electoral rules, where applicable). The submission of such a vote may be subject to strong time constraints, likely to cause a traffic overload at the level of several network resources. These include, in particular, those of the network used to route the votes, those of the server equipment designed to receive and count the votes, those of the aforementioned acknowledgement system, or any combination of these resources.

In this second example, the invention is based on processing devices 200 embedded in client equipment, UA or CPE user agents or in other equipment typically located at the edge of the network, such as access network routers, core network routers, an item of voting site access equipment or an item of server equipment responsible for processing votes. These devices 200 are configured to receive control actions decided and transmitted by a control device 100 as previously described, for example embedded in an item of control equipment CTR on the network. Such control measures aim to ensure the smooth flow of the traffic.

They consist, for example, of:
(1) monitoring a set of interface counters that report the volume of traffic passing through each of these interfaces,
(2) detecting when a threshold has been reached from a reading of these counters (for example, 70% of the bandwidth associated with an interface is currently being used to route voting traffic,
(3) implementing a traffic conditioning function based, for example, on a token bucket algorithm (as long as there are tokens in the bucket, the traffic can be routed, when there are no more tokens, traffic can be stored in a queue (until the volume of traffic falls below the 70% threshold) or redirected onto another path that is not congested but still allows the vote processing site to be reached),
(4) (re-)marking excess traffic via specific DSCP (or “DiffServ Code Point”) coding, at the UA, CPE or peripheral equipment level. For example, voting traffic is initially marked with an AF12 DSCP (which means that the traffic is stored in a particular queue) and then re-marked as AF11 or Best Effort (DSCP set to zero), when the traffic has reached the 70% threshold cited as an example,
(5) changing the metric(s) associated with one or more interface(s) so that new routes can be specifically established and used to carry vote submission and acknowledgement message traffic to the exclusion of all other traffic and/or to “force” excess traffic to take another path, where such a metric change may be a decision taken by an SDN controller who will take responsibility for instructing the relevant equipment to make the change, e.g. via a NETCONF command. Note that the policy for assigning metrics to interfaces is generally a least-cost policy that takes account of the bandwidth associated with each interface. For example, a 10 Gbit/s interface is assigned a metric of 1, while a 100 Mbit/s interface is assigned a metric of 100. If the 10 Gbit/s link achieves a load factor of 70%, the metric for the corresponding interfaces can be increased to 200, for example. In this case, the dynamic routing protocol will select lower-cost paths, for example a path through the 100 Mbit/s interface,
(6) sending a notification of reaching or exceeding a threshold to an SDN controller, which can trigger the calculation of new paths using a PCE (Path Computation Element) architecture, etc. Such control actions prevent any risk of overloading the server equipment configured to receive the votes. These control actions are executed by certain network elements (or even client equipment CPE) according to information which can be conveyed in messages conforming to the Path Computation Element Protocol (PCEP) for establishing new routes, for example.

The invention thus makes it possible to anticipate a context of overload and to make both vote submission and acknowledgement messages more fluid.

Of course, the two examples of application are given by way of illustration only, and other contexts of application of the invention could still be envisaged.

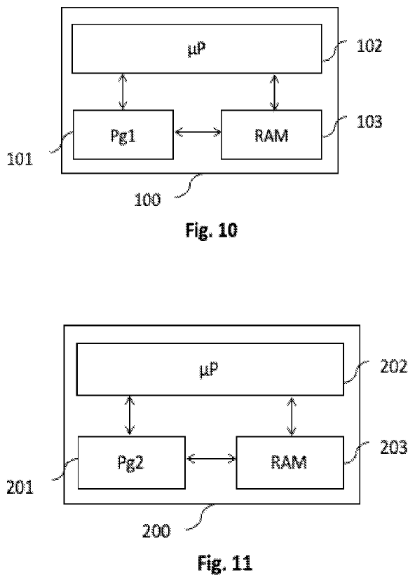

We now present, in relation to FIG. 10 an example of the hardware structure of a device 100 for controlling an access by at least one item of client equipment to an application service in a telecommunications network, said at least one item of client equipment being configured to access said application service, said device comprising a module for obtaining information about events relating to the processing by at least one item of service equipment involved in an implementation of the application service, of messages exchanged during at least one access to said application service, a module for detecting, from information obtained, a processing anomaly by at least one said item of service equipment with respect to at least one given service execution criterion; and a module for transmitting at least one control message comprising at least one control action of a processing of at least one access request to said service by said item of client equipment.

The term “module” can correspond to a software component as well as to a hardware component or a set of hardware and software components, a software component itself corresponding to one or more computer programs or sub-programs, or more generally, to any element of a program capable of implementing a function or set of functions.

More generally, such a device 100 comprises a random access memory 103 (a RAM memory, for example), a processing item 102 equipped for example with a processor and controlled by a computer program Pg1, representative of the modules for obtaining, detecting and transmitting, stored in a read-only memory 101 (a ROM memory or hard disk, for example). At initialisation, the code instructions of the computer program are for example loaded into a random access memory 103 before being executed by the processor of the processing item 102. The random access memory 103 can also contain the event information obtained.

FIG. 10 only illustrates a particular one of several possible ways of realising the device 100, so that it executes the steps of the method for controlling an access to the service as detailed above, in relation to FIG. 5 in its various embodiments. Indeed, these steps may be implemented either on a reprogrammable computing machine (a PC computer, a DSP processor or a microcontroller) executing a program comprising a sequence of instructions, or on a dedicated computing machine (for example a set of logic gates such as an FPGA or an ASIC, or any other hardware module).

In the case where the device 100 is realised with a reprogrammable computing machine, the corresponding program (i.e. the sequence of instructions) can be stored in a removable (such as, for example, an SD card, a USB flash drive, CD-ROM or DVD-ROM) or non-removable storage medium, this storage medium being partially or totally readable by a computer or a processor.

The various embodiments have been described above in relation to a device 100 integrated into an item of control equipment of a telecommunications network, but it can also be integrated into an item of service equipment or any other item of equipment of the telecommunications network.

Also shown, in relation to FIG. 11, is an example of hardware structure of a processing device 200 of a control message of an access to an application service involving at least one item of service equipment in a telecommunications network, comprising a module for receiving a control message from an item of control equipment of said telecommunications network, said control message comprising at least one action controlling a processing of at least one access request to said service by said item of client equipment, and a module for executing the control action when processing said request.

The term “module” can correspond to a software component as well as to a hardware component or a set of hardware and software components, a software component itself corresponding to one or more computer programs or sub-programs, or more generally, to any element of a program capable of implementing a function or set of functions.

More generally, such a device 200 comprises a random access memory 203 (a RAM memory, for example), a processing item 202 equipped for example with a processor and controlled by a computer program Pg2, representative of the reception and execution modules, stored in a read-only memory 201 (a ROM memory or hard disk, for example). At initialisation, the code instructions of the computer program are for example loaded into a random access memory 203 before being executed by the processor of the processing item 202. The random access memory 203 may also contain the control action received in the control message.

FIG. 11 only illustrates a particular one of several possible ways of realising the device 200, so that it executes the steps of the method for processing an access to an application service as detailed above, in relation to FIG. 6, and in its various embodiments. Indeed, these steps may be implemented either on a reprogrammable computing machine (a PC computer, a DSP processor or a microcontroller) executing a program comprising a sequence of instructions, or on a dedicated computing machine (for example a set of logic gates such as an FPGA or an ASIC, or any other hardware module).

In the case where the device 200 is realised with a reprogrammable computing machine, the corresponding program (i.e. the sequence of instructions) can be stored in a removable (such as, for example, an SD card, a USB flash drive, CD-ROM or DVD-ROM) or non-removable storage medium, this storage medium being partially or totally readable by a computer or a processor.

1. A method of controlling an access by at least one item of client equipment to an application service in a telecommunications network, said at least one item of client equipment being configured to access said application service, said method being executed by at least one control equipment and comprising:
obtaining event information relating to a processing, by at least one item of service equipment involved in implementing the application service, of messages exchanged during at least one access to said application service;
detecting, from the information obtained, a processing anomaly by at least one said item of service equipment in relation to at least one given service execution criterion; and
transmitting to said item of client equipment at least one control message comprising at least one control action of a processing of at least one access request to said service to be executed by said item of client equipment.

2. The method of controlling according to claim 1, wherein the method comprises the at least one control equipment implementing a prior learning of a classification model of an automatic detection system of said processing anomaly from a learning set comprising processing event information previously labelled using at least two classes comprising an anomaly presence class and an anomaly absence class and wherein said detection of an anomaly is performed by said system from processing event information obtained for one or more items of service equipment involved in the implementation of the relevant service, said system producing at the output one of the at least two classes.

3. The method of controlling according to claim 1, wherein said control action belongs to a group consisting of:
a control action of a temporal spread of transmissions of requests for establishing application sessions by said item of client equipment;
a control action of a number of attempts by said item of client equipment to establish an application session at said service;
a checking action on a replacement number for the telephone number associated with the service requested by said item of client equipment;
a control action of a priority of the service, comprising the configuration of priority levels assigned to the requested services and to the other services to which said item of client equipment can access;
a control action of an automatic programming of an announcement server of a replacement number for a telephone number associated with the service requested by said item of client equipment.

4. The method controlling according to claim 1, wherein said application service comprises setting up a telephone call, and said control action comprises configuring at least one telephone number, known as an alias number, to replace a telephone number associated with the service.

5. The method controlling according to when claim 1, wherein said application service comprises setting up a telephone call, and said control action comprises automatically programming a server to announce a replacement telephone number for a destination telephone number.

6. The method of controlling according to claim 1, wherein said application service comprises setting up a telephone call, and said at least one service execution criterion comprises a telephone call establishment failure rate equal to zero and a telephone call establishment delay below a predetermined threshold.

7. A method of processing of a control message of an access to an application service involving at least one item of service equipment in a telecommunications network, said method being executed by an item of client equipment configured to access said application service, said method comprising:
receiving the control message from an item of control equipment of said telecommunications network, said control message comprising at least one control action of a processing of at least one access request to said service by said item of client equipment, and
executing the control action when processing said request.

8. The method of processing according to claim 7, wherein the requested service comprises setting up a telephone call with a destination, the control action comprises configuring at least one alias telephone number of a telephone number associated with the requested service, and performing the action comprises:
modifying a header of the message requesting access to said service, comprising a replacement of the telephone number associated with the requested service by said alias telephone number.

9. A control device of an access by at least one item of client equipment to an application service in a telecommunications network, said at least one item of client equipment being configured to access said application service, said control device comprising:
at least one processor; and
at least one non-transitory computer readable medium comprising instructions stored thereon which when executed by the at least one processor configure the control device to execute a method comprising:
obtaining event information relating to the processing, by at least one item of service equipment involved in implementing the application service, of messages exchanged during at least one access to said application service;
detecting, from the information obtained, a processing anomaly by at least one said item of service equipment in relation to at least one given service execution criterion; and
transmitting to said item of client equipment at least one control message comprising at least one control action of a processing of at least one access request to said service to be executed by said item of client equipment.

10. A processing device of a control message of an access to an application service involving at least one item of service equipment in a telecommunications network, said device being implemented in an item of client equipment configured to access said application service, said processing device comprising:
at least one processor; and
at least one non-transitory computer readable medium comprising instructions stored thereon which when executed by the at least one processor configure the processing device to execute a method comprising:
receiving a control message from an item of control equipment of said telecommunications network, said control message comprising at least one control action of a processing of at least one access request to said service by said item of client equipment, and
executing the control action when processing said request.

11. A system for implementing the application service in the telecommunications network, said system comprising a plurality of items of service equipment involved in the implementation of the application service and the control device according to claim 9.

12. The system according to claim 11, which further comprises the item of client equipment.

13. At least one non-transitory computer readable medium comprising a computer program stored thereon comprising program code instructions for implementing a method of controlling an access by at least one item of client equipment to an application service in a telecommunications network, when the program is executed by at least one processor of at least one control equipment, said at least one item of client equipment being configured to access said application service, said method comprising:
obtaining event information relating to a processing, by at least one item of service equipment involved in implementing the application service, of messages exchanged during at least one access to said application service;
detecting, from the information obtained, a processing anomaly by at least one said item of service equipment in relation to at least one given service execution criterion; and
transmitting to said item of client equipment at least one control message comprising at least one control action of a processing of at least one access request to said service to be executed by said item of client equipment.
